(19) United States
(12) Patent Application Publication
(10) Pub. No.: US 2006/0006009 A1
(43) Pub. Date: Jan. 12, 2006

(54) Hybrid drive system for a vehicle and method therefor

(76) Inventor: Garth Mennenga, Phoenix, AZ (US)

Correspondence Address: WEISS & MOY PC, 4204 NORTH BROWN AVENUE, SCOTTSDALE, AZ, 85251, US

(21) Appl. No.: 10/889,649

(22) Filed: Jul. 12, 2004

(51) Int. Cl. B60K 1/00

(52) U.S. Cl. 180/65.3

(57) ABSTRACT

A hybrid drive system for a vehicle uses a portable generator which produces a single phase output. A transformer is coupled to the portable generator. The transformer is a step-up transformer which produces a three phase output. An electrical motor is coupled to the output of the transformer. A transmission is coupled to the electrical motor and to wheels of the vehicle.

### BACKGROUND OF THE INVENTION

1. Field of the Invention

This invention relates to motor vehicles and, more specifically, to a hybrid drive system for a motor vehicle which does not require the use of batteries, an inverter, or an electrical control unit.

2. Description of the Prior Art

Cars driven by electric/hybrid motors are advantageous, when compared with the normal vehicles driven by gasoline/diesel powered engines. The main advantage is that electric cars are so clean in exhaust gas emission as to cause little to no air pollution. Another advantage pf electric vehicles is that electric vehicles produce very little noise.

However, electric vehicles do have several problems. The main problem is the cruising distance is short due to the poor capacity of the batteries presently available, and the energy cost per unit traveling distance traveled is still expensive.

To eliminate the above problem, there have been proposed various hybrid vehicles driven chiefly by a combination of an electric motor which is supplied electric power from batteries and an internal combustion engine using fuel such as gasoline or light oil. However, all of these designs all require the use of batteries, an invertor, and an electric control unit which complicates the design of the hybrid vehicles and increases the cost. Furthermore, when the batteries need to be replaced, the old batteries have ben alleged to be of a worst contaminate of the environment than using a gasoline/diesel powered vehicle.

Therefore, there is a need for an improved hybrid drive system for vehicles. The improved hybrid drive system must overcome the problems associated with prior art designs. The improved hybrid drive system must overcome the problems associated with prior art designs by simplifying current hybrid drive systems.

### SUMMARY OF THE INVENTION

In accordance with one embodiment of the present invention, it is an object of the present invention to provide an improved hybrid drive system for vehicles.

It is another object of the present invention to provide an improved hybrid drive system that overcome the problems associated with prior art designs.

It is another object of the present invention to provide an improved hybrid drive system that overcomes the problems associated with prior art designs by simplifying current hybrid drive systems.

It is another object of the present invention to provide an improved hybrid drive system that overcomes the problems associated with prior art designs by simplifying current hybrid drive systems thereby lowering the cost of the hybrid vehicle.

It is another object of the present invention to provide an improved hybrid drive system that overcomes the problems associated with prior art designs by eliminating the use of batteries for powering the hybrid vehicle.

### BRIEF DESCRIPTION OF THE EMBODIMENTS

In accordance with one embodiment of the present a hybrid drive system for a vehicle is disclosed. The hybrid drive system uses a portable generator which produces a single phase output. A transformer is coupled to the portable generator. The transformer is a step-up transformer which produces a three phase output. An electrical motor is coupled to the output of the transformer. A transmission is coupled to the electrical motor and to wheels of the vehicle.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified functional block diagram of the hybrid drive system of the present invention.

FIG. 2 is a simplified view of an electric motor used in the hybrid drive system of the present invention.

### DETAILED DESCRIPTION OF THE PREFERRED EMBODIMENT

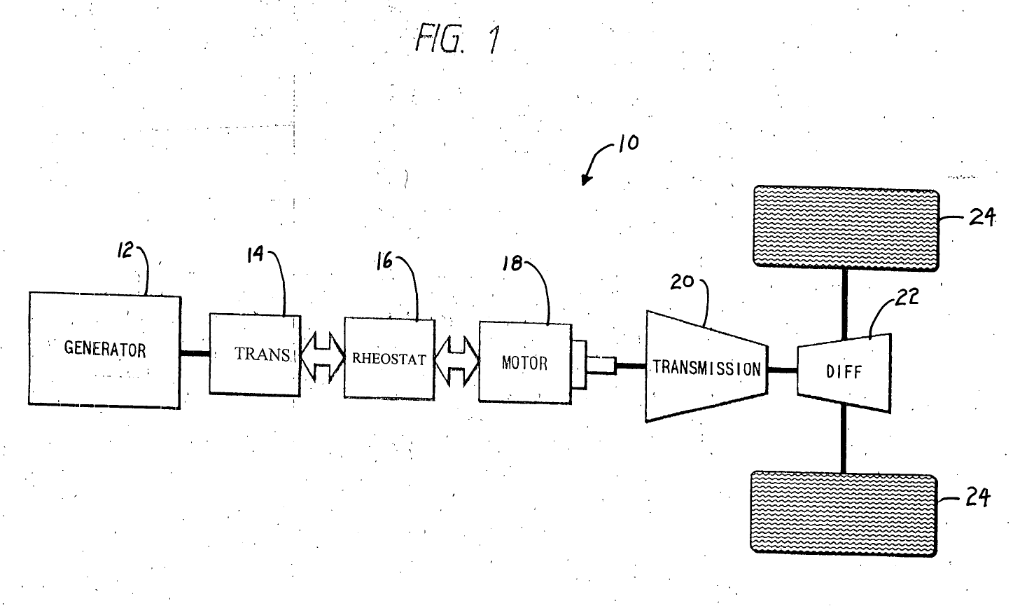

Referring to FIG. 1, the hybrid drive system 10 of the present invention is shown. The hybrid system 10 simplifies existing systems by not requiring the use of batteries, an inverter, or an electronic control unit.

The hybrid drive system 10 of the present invention has a gasoline powered generator 12. The gasoline powered generator 12 is a small portable generator similar to those which may be used as an emergency generator at a home. The gasoline powered generator 12 is able to generate anywhere from 1000 to over 12,000 watts of power. The gasoline powered generator 12 may be an AC or DC powered generator. The gasoline powered generator 12 will produce a single phase output.

A transformer 14 is coupled to the output of the gasoline powered generator 12. The transformer 14 is a step-up transformer 14 which will take the single phase AC or DC power generated by the gasoline powered generator 12 and step it up to a three phase AC or DC power.

The output of the transformer 14 is coupled to a rheostat 16. The rheostat 16 is used to control the voltage flow via adjustable resistive elements internal to the rheostat 16. By adjusting the voltage flow, one can control the power of the hybrid drive system 10. Less voltage means less power to power the vehicle. More voltage means more power to drive the vehicle. The rheostat 16 is able to control the amount of electrical power supplied to the hybrid drive system 10 without altering the of speed of the gasoline powered generator 12.

The output of the rheostat 16 is coupled to an electric motor 18. The electric motor 18 is different from the prior art in that the electric motor 18 is powered not by a set of batteries but by the step-up power being outputted from the step-up transformer 14 and controlled by the rheostat 16. The electric motor 18 uses magnets to create motion. Inside the electric motor 18 the attracting and repelling forces of the magnets create rotational motion.

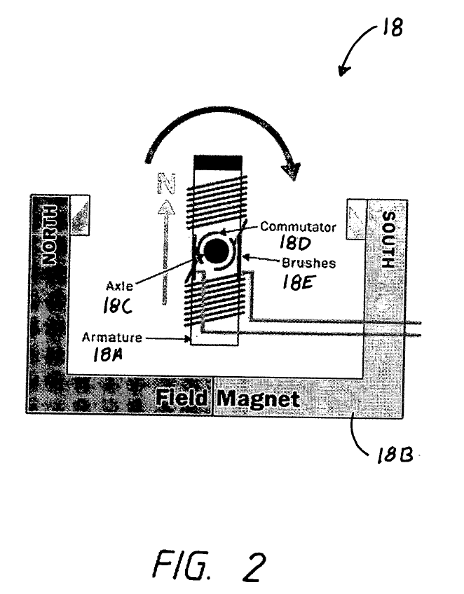

Referring to FIG. 2, simplified block diagram of the electric motor 18 is shown. The electric motor 18 will have two magnets: an armature (or rotor) 18A is an electromagnet, while the field magnet 18B is a permanent magnet (the field magnet 18B is generally an electromagnet as well). The armature 18A is an electromagnet made by coiling thin wire around two or more poles of a metal core. The armature 18A has an axle 18C, and a commutator 18D is attached to the axle 18C.

The commutator 18D and brushes 18E work together to let current flow to the armature (or rotor) 18A, and also to flip the direction that the electrons are flowing at just the right moment. The contacts of the commutator 18D are attached to the axle 18C of the armature (or rotor) 18A, so they spin. The brushes 18E are just two pieces of springy metal or carbon that make contact with the contacts of the commutator 18D.

Referring back to FIG. 1, the electric motor 18 is coupled to a transmission 20. The transmission 20 primary job is to allow the electric motor 18 to operate in its narrow range of speeds while providing a wide range of output speeds. Without the transmission 20, vehicles would be limited to one gear ratio, and that ratio would have to be selected to allow the vehicle to travel at the desired top speed.

The output of the transmission 20 is coupled to a differential 22. The differential 22 has three jobs: 1) To aim the power of the electric motor 18 at the wheels 24; 2) To act as the final gear reduction in the vehicle, slowing the rotational speed of the transmission 20 one final time before it hits the wheels 24; and 3) To transmit the power to the wheels 24 while allowing them to rotate at different speed.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A hybrid drive system for a vehicle comprising:
a portable generator which produces a single phase output;
a transformer coupled to the portable generator wherein the transformer is a step-up transformer which produces a three phase output;
an electrical motor coupled to the output of the transformer; and
a transmission coupled to the electrical motor and to wheels of the vehicle.

2. A hybrid drive system for a vehicle in accordance with claim 1 further comprising a rheostat coupled to the output of the transformer to control the voltage flow from the transformer to the electrical motor.

3. A hybrid drive system for a vehicle in accordance with claim 1 further comprising a differential coupled to the transmission for transmitting power to the wheels.

4. A hybrid drive system for a vehicle in accordance with claim 1 wherein the portable generator generates 1000 to over 12,000 watts of power.

5. A hybrid drive system for a vehicle in accordance with claim 1 wherein the portable generator generates an AC output.

6. A hybrid drive system for a vehicle in accordance with claim 1 wherein the portable generator generates an DC output.

7. A hybrid drive system for a vehicle comprising:
a portable generator which produces a single phase output;
a transformer coupled to the portable generator wherein the transformer is a step-up transformer which produces a three phase output;
a rheostat coupled to the output of the transformer to control the voltage flow from the transformer;
an electrical motor coupled to the output of the transformer;
a transmission coupled to the electrical motor and to wheels of the vehicle; and
a differential coupled to the transmission for transmitting power to the wheels.

8. A hybrid drive system for a vehicle in accordance with claim 7 wherein the portable generator generates 1000 to over 12,000 watts of power.

9. A hybrid drive system for a vehicle in accordance with claim 7 wherein the portable generator generates an AC output.

10. A hybrid drive system for a vehicle in accordance with claim 7 wherein the portable generator generates an DC output.
